(19) United States
(12) Patent Application Publication
(10) Pub. No.: US 2025/0375811 A1
(43) Pub. Date: Dec. 11, 2025

(54) GOLD PASTE SUITABLE FOR DIP COATING AND DIP COATING METHOD USING THE GOLD PASTE

(71) Applicant: TANAKA KIKINZOKU KOGYO K.K., Tokyo (JP)

(72) Inventors: Kenichi INOUE, Kanagawa (JP); Fumihiko SAITO, Kanagawa (JP); Yuya SASAKI, Kanagawa (JP); Saori YOKOKAWA, Kanagawa (JP); Yusuke AIZAWA, Kanagawa (JP)

(73) Assignee: TANAKA KIKINZOKU KOGYO K.K., Tokyo (JP)

(21) Appl. No.: 18/833,829

(22) PCT Filed: Jan. 24, 2023
(86) PCT No.: PCT/JP2023/001997

§ 371 Date: Feb. 27, 2025

(30) Foreign Application Priority Data
Jan. 27, 2022 (JP) 2022-010967

(51) Int. Cl. B22F 1/107; B05D 1/18; B22F 1/054

(52) U.S. Cl. CPC B22F 1/107; B05D 1/18; B22F 1/056; B22F 2301/255; B22F 2304/056; B22F 2304/058

(57) ABSTRACT

Provided is a gold paste for forming a gold film by dip coating on an appropriate member to be coated. The gold paste contains a gold powder with a purity of 99.9% by mass or more, and having an average particle size of 0.1 μm or more and 0.5 μm or less, and an organic solvent. An organic solvent used is one having a distance Ra in a Hansen solubility parameter from the gold powder of 7.0 MPa^{1/2} or more, and having an intrinsic viscosity value measured at a temperature of 25° C. and a shear rate of 4/s with a rotational viscometer of 1.5 mPa·s or more and 6.5 mPa·s or less. The gold paste of the present invention has favorable application properties in dip coating, and formation of a peak, and thickness unevenness in the member to be coated at the time of pulling are suppressed. Besides, surface roughness of the gold paste in a dipping tank is also reduced.

### BACKGROUND OF THE INVENTION

### Field of the Invention

The present invention relates to a gold paste suitable for use for forming, bonding, sealing, or the like of electrodes and wirings in the field of electronics such as semiconductor devices and semiconductor elements. More particularly, it relates to a gold paste suitable for application by dip coating that can attain favorable shape stability of a coating film after the application. Besides, the present invention relates to a method for applying a gold paste by a dip coating method using the gold paste.

### Description of the Related Art

In forming, bonding, and sealing of electrodes (bumps) and wirings for various uses in electric and electronic components, semiconductor devices, semiconductor elements, power devices, MEMS and the like, brazing and soldering materials have been conventionally widely used, but in recent years, use of metal pastes (metal slurries) has been expanded. The present applicant has also proposed that a gold paste (gold slurry) obtained by mixing, with an organic solvent, a metal powder of gold (Au) or the like with a high purity (99.9% by mass or more) and of submicron order (1 μm or less) is useful for the above-described uses (for example, Patent Documents 1 and 2).

In forming or bonding an electrode or wiring with a metal paste, it is necessary, after applying the metal paste onto a member to be coated, such as a substrate, to volatilize components excluding the metal powder by drying. Since the gold paste proposed by the present applicant basically contains only the gold powder and the organic solvent, the organic solvent and the like can be comparatively easily removed by volatilization. Besides, the gold powder of the gold paste contains highly pure and fine gold particles, and can form a dense sintered body when sintered at a low temperature (300° C. or less). In production of semiconductor elements and devices for which low-temperature processes are recommended, such low-temperature sinterability is advantageous.

As a method for applying a gold paste to a member to be coated, such as a substrate or an element, an application method for supplying an appropriate amount of the gold paste to a surface of the member to be coated, such as a spin coating method, a screen printing method, an inkjet method, or a dripping method, has been conventionally widely employed. In the gold paste proposed by the present applicant, as a reference for optimizing formability of the gold paste applied by such an application method, attention is paid to a thixotropy index value (TI value) for optimization thereof. cl PRIOR ART DOCUMENT

### Patent Document

### Patent Document 1

Japanese Patent No. 5613253

### Patent Document 2

Japanese Patent Application Laid-Open No. Hei 9-20903

### Patent Document 3

Japanese Patent No. 6254015

### SUMMARY OF THE INVENTION

### Technical Problem

As a method for applying a metal paste, dip coating is known in addition to the above-described methods. The dip coating is a method in which a member to be coated is dipped in and pulled out of a tank holding a metal paste (dipping tank) for applying the metal paste. The dip coating is a method by which a metal paste can be uniformly and efficiently applied to a member to be coated, and is an application method excellent in area efficiency and having slight foreign matter contamination. The dip coating of a metal paste is employed in, for example, partial application to a wire-shaped or chip-shaped member to be coated used in a semiconductor element such as a sensor element.

Requirements in the application of a metal paste by the dip coating include uniformity in the thickness of a coating film applied to a member to be coated. In the dip coating, a metal paste is drawn in a tear shape in pulling up the member to be coated, and therefore, the thickness is liable to be larger around the center in a lower part of the member to be coated. As a result, a peak may be formed in the lower part of the member to be coated. Such a peak is not preferable from the viewpoint of appearance, and in addition, deteriorates the dimensional accuracy of the member, and affects the yield as an electric or electronic component. Therefore, a metal paste suitable for dip coating is required to have dimensional stability in the thickness of a coating film at the time of pulling up.

Besides, in pulling up the member to be coated, roughness such as a peak or a recess may be caused also on the surface of the metal paste held in the dipping tank. When the roughness is thus caused on the surface of the metal paste, it is necessary to flatten the surface by squeegeeing every time of dipping. Here, the metal paste adheres to the squeegee, resulting in reducing the yield.

The formation of a peak in the lower part of a member to be coated, and the surface roughness of the metal paste in the dipping tank caused as described above in the dip coating are affected by a pulling speed after dipping the member to be coated, and these phenomena easily occur when the pulling speed is too high. Therefore, the formation of a peak and the like can be suppressed when the pulling speed is reduced, which deteriorates production efficiency of elements or the like. Accordingly, application properties are required to be improved from the side of the metal paste.

An example of improvement of a metal paste in consideration of the formation of a peak in a coating film in the dip coating includes a metal paste (conductive paste) of Patent Document 3. This metal paste is a metal paste that contains a flaky silver powder, a silver nanoparticle, and a thermosetting resin, and has a TI value set to 1.5 to 4.5. In this metal paste, a flaky silver powder of 2 μm or more and 20 μm or less is used, and a thermosetting resin to be used in an adhesive is further mixed therewith, and thus, thixotropy of the metal paste is increased, and appearance failure such as a peak otherwise caused in dip coating is suppressed.

Here, the present applicant has confirmed that even the gold pastes proposed by the present applicant (Patent Documents 1 and 2) have some points to be improved in the shape stability of a coating film and the surface roughness of the metal paste in the dipping tank as described above in the dip coating. In this regard, as compared with the metal paste of Patent Document 2, although the metal species is different, a metal paste suitable for the dip coating can be possibly produced by employing a similar configuration. In consideration of the properties of the gold paste proposed by the present applicant, however, the application of the flaky powder of micron order and the method employing the addition of the thermosetting resin as in Patent Document 2 are not preferred.

Specifically, that the particle size of the gold powder contained in the gold paste is micron order affects the low-temperature sinterability of the gold paste proposed by the present applicant. The low-temperature sinterability of the metal paste is an extremely significant property in the production process of semiconductor devices and the like, and cannot be sacrificed for the application properties in dip coating.

Besides, the addition of a resin having a high boiling point such as a thermosetting resin to a metal paste is also not a preferable method. When a resin having a high boiling point is contained in a metal paste, the resin cannot be completely decomposed by heating for drying or sintering after the application, and may remain in an electrode or bonding portion after the heating. Such residual of an organic compound derived from the resin can be a cause of contamination of the inside of a semiconductor device or the atmosphere of the production thereof, and it is concerned that semiconductor performances and the like may be affected.

The present invention was developed against the backgrounds described above, and provides, based on the gold paste proposed by the present applicant and without impairing the original properties and merits thereof, a gold paste that is favorable in application properties in dip coating, and is capable of suppressing formation of a peak and thickness unevenness in a member to be coated, and surface roughness of the metal paste in a dipping tank otherwise caused at the time of pulling.

### Solution to Problem

The present invention solving the above-described problems is drawn to a gold paste containing a gold powder and an organic solvent, wherein the gold powder contains gold with a purity of 99.9% by mass or more, and has an average particle size of 0.1 μm or more and 0.5 μm or less, and the organic solvent has a distance Ra in a Hansen solubility parameter from the gold powder of 7.0 MPa1/2 or more, and has an intrinsic viscosity value measured at a temperature of 25° C. and a shear rate of 4/s with a rotational viscometer of 1.5 mPa·s or more and 6.5 mPa·s or less.

In order to solve the above-described problems with maintaining the properties, such as the low-temperature sinterability, of the gold paste proposed by the present applicant (Patent Documents 1 and 2), a gold powder needs to be a similar one. Besides, it is necessary to avoid addition of a resin such as a thermosetting resin. In consideration of these prerequisites, it is deemed that a suitable method is optimization of the organic solvent and the adjustment of properties of the gold paste thereby. The present inventors have made earnest studies based on these principles, resulting in determining to use an organic solvent having the distance Ra in the Hansen solubility parameter from the gold powder falling within the prescribed range as described above.

The Hansen solubility parameter (hereinafter sometimes abbreviated as HSP) is one of methods for defining a solubility parameter of a solvent. The HSP is a geometric position (vector) indicating, in a three-dimensional space, what is called a Hildebrand solubility parameter (SP value) divided into three components of a dispersion term (βd), a polar term (βp), and a hydrogen bond term (βh). The HSP is conventionally used as an index for estimating affinity between a solvent and a solute, and is a parameter used for presuming to what extent a given solvent can dissolve a given solute. In a gold paste dealt with in the present invention, gold particles are dispersed without being dissolved in a solvent, and therefore, the conventional concept of the HSP has been applied in only a few cases. In recent years, however, it has been recognized that the HSP is useful for estimating affinity, with a solvent, also of a solid dispersoid. In addition, also for a solid dispersoid, technique for measuring the HSP (βd, βp, βh) thereof has become known. Considering these points, the present inventors have found that it is useful to make examination, in evaluation of application properties and the like of a gold paste, based on the HSP of an organic solvent and a gold powder, and have decided to employ it as a configuration of the present invention.

Besides, the present inventors have presumed, regarding an organic solvent to be used, that not only the distance Ra in the HSP from the gold powder but also the intrinsic viscosity value affect the formation of a peak in a coating film, and hence a suitable range thereof should be set. In the present invention, owing to these features, the shape of a gold paste applied to a member to be coated by dipping is controlled to suppress the formation of a peak and the like, and the state of the gold paste in a dipping tank is optimized. The gold paste of the present invention, and a dip coating method using the same will now be described in detail.

### (A) Gold Paste of the Invention

The gold paste of the present invention contains a gold powder and an organic solvent. In the following description, configurations of these will be described.

### (1) Gold Powder

The gold powder of the gold paste of the present invention is one containing gold with a purity (gold concentration) of 99.9% by mass or more, and having an average particle size of 0.1 μm or more and 0.5 μm or less. Similarly to a conventional art, the gold paste of the present invention is formed into a sintered body after application when used as an electrode or a bonding material. When used as a bonding material or the like, a metal powder sintered body needs to be further compressed under pressure to be densified. The purity and the average particle size of the gold powder of the metal paste are specified for clarifying suitable conditions in consideration of formation and use of the metal powder sintered body. The purity of the gold powder is specified as 99.9% by mass or more because gold with a low purity has high hardness, and hence plastic deformation is difficult to proceed in densifying the sintered body by pressure application. Besides, the average particle size of the gold powder is specified as 0.1 μm or more and 0.5 μm or less because a sintering temperature is high in using a gold powder having a particle size over 0.5 μm, and the property corresponding to the prerequisites of the gold paste of the present invention, that is, the low-temperature sinterability, cannot be exhibited. Besides, 0.1 μm is specified as the lower limit because particles smaller than this particle size easily agglomerate when formed into a paste.

The purity and the average particle size of the gold powder of the gold paste can be measured by sampling the gold paste and volatilizing the organic solvent therefrom. The purity of the gold powder can be measured by not only analysis by inductively coupled plasma atomic emission spectroscopy (ICP) but also energy dispersive X-ray spectrometry (EDX), X-ray fluorescence spectrometry (XRF), or the like. For the average particle size of the gold powder, the gold powder is observed and imaged with a microscope (an optical microscope, an electron microscope (SEM, or TEM), or the like), a plurality of particles of the gold powder in the thus obtained photograph or image are measured for the particle size, and an average value of these sizes can be determined as the average particle size. In measuring the particle size, it is preferable that a long diameter and a short diameter of each particle are measured to calculate the particle size by a biaxial method. Alternatively, computer software such as image analysis software may be appropriately used.

Although the gold powder contains high purity gold as described above, it may contain unavoidable impurities. Examples of unavoidable impurity elements include Na, Al, Fe, Cu, Se, Sn, Ta, Pt, Bi, Pd, S, Ag, Br, and Si. A total amount of the unavoidable impurity elements is preferably 500 ppm or less, and more preferably 300 ppm or less. These unavoidable impurities are present in a state of adsorbing or adhering to the surface of the gold powder in some cases, and can be present in a state of being reacted or alloyed with the gold powder.

Besides, as clarified in Patent Document 2 described above, a chloride ion content in the gold powder of the gold paste is preferably reduced. A chloride ion is at risk of remaining, without being completely gasified, through drying and sintering of the gold paste, and at risk of changing into an acidic liquid in the presence of moisture to corrode an electrode or a bonding portion obtained therefrom. The chloride ion content in the gold powder is preferably 100 ppm or less. Besides, Patent Document 2 describes that a harmful effect of the reduction of the chloride ion in the gold powder is agglomeration of the gold powder when formed into a paste. It is described that a method for improving the agglomerating property is treatment of the gold powder with a cyanide solution. Such a treatment is effective for the gold powder of the gold paste of the present invention. Therefore, the gold powder may contain a prescribed amount of a cyanide ion in some cases. In these cases, a cyanide ion content is preferably 10 ppm or more and 1000 ppm or less.

There arises, however, no problem in the present invention even when the chloride ion and cyanide ion contents in the gold powder are out of the above-described ranges. This is because the application properties (such as the formation of a peak in a coating film and the surface roughness of the gold paste) of the gold paste of the present invention in the dip coating are not affected by the chloride ion and the cyanide ion. The components of the gold powder, not limited to the chloride ion and the like, can affect the surface state of the gold powder, and hence can affect the HSP of the gold powder. Even in such a case, when the distance Ra in the HSP between the gold powder and the organic solvent falls in the above-described range, the object of the present invention is achieved. The measurement of the HSP of the gold powder will be described below.

A method for producing the gold powder is not especially limited. The gold powder is produced preferably by a wet reduction method as in the conventional technique. The production of a gold powder by the wet reduction method basically includes a step of precipitating gold by adding a reducing agent to a gold compound solution. In the production of a gold powder by the wet reduction method, reduction and precipitation of gold are performed once or a plurality of times, and thus, a gold powder having a prescribed particle size can be produced. A preferable method is one in which a step of precipitating gold on a surface of a nuclear particle by supplying, to a solution containing gold ultrafine particles dispersed as the nuclear particle, a gold compound solution and a reducing agent is performed once or more times to adjust the particle size. As the gold compound solution used in the wet reduction method, an inexpensively and stably supplied chloroauric acid solution is preferred. Besides, the gold powder produced by the wet reduction method is preferably washed with an appropriate solvent.

### (2) Organic Solvent

The gold paste of the present invention is characterized, for improving the application properties (such as the formation of a peak in a coating film and the surface roughness of the gold paste), by use of an organic solvent satisfying the two requirements of (a) the distance Ra in the HSP from the gold powder of 7.0 MPa1/2 or more, and (b) the intrinsic viscosity value measured at a temperature of 25° C. and a shear rate of 4/s with a rotational viscometer of 1.5 mPa·s or more and 6.5 mPa·s or less.

### (a) Distance Ra in HSP of Organic Solvent from Gold Powder

The distance Ra in the Hansen solubility parameter from the gold powder refers to a distance between coordinates of the HSP of the gold powder and the HSP of the organic solvent. The HSPs being close to each other, namely, the distance Ra having a small value, means that an interaction distance is small, and affinity between the gold powder and the organic solvent is high, which affects dispersibility and wettability. Such a distance Ra in the HSP can be calculated in accordance with the following equation 1 based on the HSP (βd_{G}, βp_{G}, βh_{G}) of the gold powder and the HSP (βdₛ, βpₛ, βhₛ) of the organic solvent:

$$\begin{matrix}Ra = ( {( 4 \times {( δ {d}_{G} - δ {d}_{s} )}^{2} + {( δ {p}_{G} - δ {p}_{s} )}^{2} + {( δ {h}_{G} - δ {h}_{s} )}^{2} )}^{1 / 2} \\ δ {d}_{G} , δ {p}_{G} , δ {h}_{G} : δ d , δ p , δ h of gold powder \\ δ {d}_{s} , δ {p}_{s} , δ {h}_{s} : δ d , δ p , δ h of organic solvent\end{matrix} \qquad [ Expression 1 ]$$

The values of the dispersion term βd, the polar term βp, and the hydrogen bond term μh for the calculation related to the HSP and calculation methods are described in, for example, “INDUSTRIAL SOLVENTS HANDBOOK” (pp. 35 to 68, Marcel Dekker, Inc., issued in 1996), “HANSEN SOLUBILITY PARAMETERS: A USER'S HANDBOOK” (pp. 1 to 41, CRC Press, issued in 1999)”, “DIRECTORY OF SOLVENTS” (pp. 22 to 29, Blackie Academic & Professional, issued in 1996), and the like. As the calculation method of each component of the HSP, calculation can be conducted based on atom group contribution such as VKH method and S & P method. Besides, as a general simpler examining method, values calculated by software and included in database are used in many cases. As such software, values of database included in computer software “Hansen Solubility Parameters in Practice (HSPIP), version 4.1.03” (written by Steven Abbott, Charles M. Hansen, and Hiroshi Yamamoto) can be used.

On the other hand, reference values of the HSP of solid particles such as a gold powder are not included in the above-described database and the like in many cases. For the HSP of a solid particle such as a gold particle, measurement methods by a visual observation method, an interfacial settling velocity method, and a dynamic light scattering method based on the Hansen method as well as an inverse gas chromatography method (IGC method) and the like are known. In the measurement method based on the Hansen method, a plurality of solvents having known HSP values are used for obtaining the HSP of a solid particle with reference to behavior of the solid particle in these solvents. For example, in the visual observation method, dispersibilities and affinities obtained by dispersing a target solid particle in a plurality of solvents having known HSP values are visually scored, and the HSP value of the solid particle is estimated based on the HSP values of solvents having prescribed or higher scores. In the dynamic light scattering method, particles are dispersed in a plurality of solvents to measure the particle size. Here, the degree of dispersion or agglomeration of the particles in the solvent varies depending on the degree of affinity between the solvent and the particle, and hence the measured values of the particle size are different in the respective solvents. Based on these different particle sizes, the affinity between the solvent and the particle is evaluated. In these measurement methods based on the Hansen method, the HSPs (βd, βp, βh) of solvents evaluated to have high affinity with the target solid particle are plotted in a coordinate space to obtain a minimum ball (Hansen ball) capable of encompassing the HSPs of solvents satisfying the score and a reference value (threshold) of the affinity. Then, the center coordinate of the minimum ball (Hansen ball) is defined as the HSP (βd, βp, βh) of the particle. Besides, the IGC method is a method in which solid particles are filled in a column, and a probe molecule having a known HSP value is allowed to pass through the column to evaluate the adsorption property to the solid particles. As a specific method, dichloromethane, toluene, chloroform or the like is used as the probe molecule to measure a retention volume in each probe molecule, and thus, the HSP value of the solid particle is calculated.

The organic solvent used in the present invention is an organic solvent having the distance Ra in the HSP of 7.0 MPa1/2 or more. An organic solvent having Ra less than 7.0 MPa1/2 has too high affinity with the gold particle, and hence the resultant gold paste exhibits behavior similarly to an elastic body. Therefore, it is difficult to control the shape of the gold paste applied, and in addition, the surface of the gold paste in the dipping tank is liable to be roughened.

The upper limit of the distance Ra in the HSP of the organic solvent used in the present invention is not especially limited, and is preferably 20 MPa1/2 or less. An organic solvent having an excessively large distance Ra in the HSP is poor in the affinity with the gold powder, and is concerned to be separated during storage or use. Besides, according to examinations made by the present inventors, some of organic solvents having the distance Ra in the HSP over 20 MPa1/2 contain halogen (such as fluorine) as a constituent element, or have a too low boiling point, and many of these are not preferable in relation to the use of the present invention. According to the examinations made by the present inventors, the upper limit of the distance Ra in the HSP is more preferably 18.3 MPa1/2 or less, and within this range, the gold paste is difficult to separate, and can exhibit suitable application properties.

### (b) Intrinsic Viscosity Value of Organic Solvent

The organic solvent used in the present invention is also required to have an intrinsic viscosity value measured at a temperature of 25° C. and a shear rate of 4/s with a rotational viscometer falling in a prescribed range. In particular, use of an organic solvent having an excessively large intrinsic viscosity value can affect the application properties such as the formation of a peak in applying the gold paste. On the other hand, in using an organic solvent having an excessively small intrinsic viscosity value, it is concerned that the gold powder and the organic solvent may be separated from each other. According to the examinations made by the present inventors, it has been confirmed that when an organic solvent having an intrinsic viscosity value of 1.5 mPa·s or more and 6.5 mPa·s or less is used, suitable application properties can be obtained without causing separation of the gold paste, and from this viewpoint, the range of the intrinsic viscosity value is set.

The suitable range of the intrinsic viscosity value of the organic solvent in the present invention is based on a value actually measured in terms of the organic solvent. The intrinsic viscosity value of an organic solvent is measured at a temperature of 25° C. and a shear rate of 4/s with a rotational viscometer. In the measurement, it is preferable that the measurement is performed a plurality of times (preferably three times or more) to determine an average value thus obtained as the intrinsic viscosity of the organic solvent.

### (c) Other Configurations and Specific Examples of Organic Solvent

Besides, the organic solvent used in the present invention is preferably an organic solvent having a boiling point of 140° C. or more and 360° C. or less. An organic solvent having a boiling point less than 140° C. has a high evaporation rate, and is not suitable in handleability in dip coating performed at ordinary temperature. Besides, taking a drying step of the gold paste performed after the dip coating into consideration, the boiling point of the organic solvent is preferably 140° C. or more. On the other hand, it is concerned that an organic solvent having a boiling point over 360° C. may remain in an electrode or bonding portion formed after drying and sintering the gold paste applied.

Furthermore, when a suitable range is examined from an aspect of the chemical structure of an organic solvent, the organic solvent used in the present invention is preferably an organic solvent not containing a hydroxyl group at the end of the structural formula. An organic solvent containing a hydroxyl group in the structure (primary alcohol) sometimes changes in the structure through a catalyst reaction with a gold powder. In consideration of stable paste application, an organic solvent containing no hydroxyl group is preferred. Besides, in consideration of the above-described suitable range of the boiling point, an organic solvent having 5 or more and 20 or less carbon atoms is preferred.

Based on the above description of the organic solvent used in the present invention, specific examples of a preferable organic solvent include bis (2-butoxyethyl) ether (DGDE), dodecyl benzene, 2-ethylhexyl acetate, and pentadecane.

The organic solvent used in the present invention is preferably a single solvent containing one organic solvent, and may be a mixed solvent containing a mixture of a plurality of organic solvents. Even a mixed solvent may be used as long as the HSP conditions described above are satisfied, and it is preferable that the intrinsic viscosity value and the like thereof also satisfy their suitable conditions. It is noted that the HSP of a mixed solvent can be calculated based on a volume ratio between the HSPs of organic solvents to be mixed. For example, the HSP (βdₘ, βpₘ, βhₘ) of a mixed solvent containing two organic solvents (a solvent A and a solvent B) can be calculated in accordance with the following equation 2 based on the HSP (βd_{A}, βp_{A}, βh_{A}) of the solvent A, the HSP (βd_{B}, βp_{B}, βh_{B}) of the solvent B, and a mixing ratio between the solvent A and the solvent B (volume ratio: a, b (a+b=1)).

$$\begin{matrix}[ δ {d}_{m} , δ {p}_{m} , δ {h}_{m} ] = [ ( a \times δ {d}_{A} + b \times δ {d}_{B} ) , ( a \times δ {p}_{A} + b \times δ {p}_{B} ) , ( a \times δ {h}_{A} + b \times δ {h}_{B} ) ] \\ δ {d}_{m} , δ {p}_{m} , δ {h}_{m} : δ d , δ p , δ h of mixed solvent \\ δ {d}_{A} , δ {p}_{A} , δ {h}_{A} : δ d , δ p , δ h of solvent A \\ δ {d}_{B} , δ {p}_{B} , δ {h}_{B} : δ d , δ p , δ h of solvent B \\ a : mixing ratio of solvent A , b : mixing ratio of solvent B\end{matrix} \qquad [ Expression 2 ]$$

Besides, for specifying (analyzing) a used organic solvent in relation to the gold paste of the present invention, the type or structure of the organic solvent can be grasped by any one of or a combination of known analysis methods such as column chromatography (GC), column chromatography-mass spectrometry (GC-MS), Fourier transform infrared spectroscopy (FT-IR), thermogravimetry-differential thermal analysis (TG-DTA), and nuclear magnetic resonance analysis (NMR). Then, regarding the thus specified organic solvent, the HSP can be calculated and the intrinsic viscosity value can be measured by the above-described methods.

### (3) Method for Producing Gold Paste of the Invention, and Another Configuration

The gold paste of the present invention described so far is configured by dispersing the above-described gold powder in the organic solvent. As a method for producing the gold paste of the present invention, the production can be performed by mixing the gold powder and the organic solvent. The gold powder and the organic solvent can be mixed at room temperature. Besides, when an additive described below is to be added, it may be added simultaneously with the gold powder and the organic solvent, or after mixing the gold powder and the organic solvent.

The content ratio (content) of the gold powder in the gold paste is preferably 85% by mass or more and 97% by mass or less based on the total mass of the gold paste. When the content ratio is lower than 85% by mass, the gold powder is liable to settle to be easily separated from the solvent. Besides, when a gold paste having a low gold content ratio is used, the amount of the gold powder applied to a member to be coated is also reduced, and hence, dipping and drying step need to be performed a plurality of times, which lowers the productivity. On the other hand, when the content ratio is over 97% by mass, it is concerned that the gold powder may agglomerate, which makes it difficult, at the time of dipping, to apply the gold powder uniformly onto a member to be coated. When the content ratio of the gold powder is over 97% by mass, a gold paste application surface is liable to be roughened even if an organic solvent having proper HSP and intrinsic viscosity value is used. The content ratio of the gold powder in the gold paste is more preferably 95% by mass to 96% by mass.

Besides, the gold paste of the present invention contains, as the basic configuration, the two constituent elements of the gold powder and the organic solvent, and may appropriately contain an additive. As the additive, one or more selected from acrylic resins, cellulose resins, and alkyd resins may be contained. When such a resin is further added, agglomeration and separation of the gold powder in the paste is prevented so that a more homogeneous coating film can be formed. An example of the acrylic resins includes a methyl methacrylate polymer, an example of the cellulose resins includes ethylcellulose, and an example of the alkyd resins includes a phthalic anhydride resin. Among these, ethylcellulose is particularly preferred.

The viscosity of the entire gold paste of the present invention is not especially limited. The viscosity of the gold paste is adjusted in accordance with not only the intrinsic viscosity of the organic solvent described above but also the content ratio of the gold powder in the gold paste. The viscosity of the gold paste does not directly affect the application properties and the shape stability of a coating film, that is, the problems to be solved by the present invention. Even if the viscosity of the gold paste is low, when the intrinsic viscosity of the organic solvent exceeds the above-described range, a peak or the like may be caused in some cases. Besides, when the intrinsic viscosity of the organic solvent is appropriate, favorable application properties can be obtained even if the gold paste has a comparatively high viscosity. When the organic solvent described above is used with the gold powder dispersed therein in a suitable content ratio, the viscosity of the gold paste is liable to have a viscosity value of 3000 Pa·s or less when measured at a temperature of 25° C. and a shear rate of 0.4/s with a rotational viscometer, and this range is preferred.

### (B) Dip Coating Method of the Invention

Next, a method for applying a gold paste by a dip coating method using the gold paste of the present invention will be described. The application of the gold paste of the present invention can be basically performed in accordance with a conventional dip coating method. Specifically, at least a part of a member to be coated is dipped in and then pulled out of a gold paste held in a dipping tank, and thus, the gold paste is applied to the member to be coated. Therefore, the method is the same as the conventional method except that the gold paste supplied to and held in the dipping tank is the gold paste of the present invention. For the application of a paste, such as a gold paste, by dip coating, various dip coaters are commercially available, and any of these can be used without limitation.

In the present invention, a member to be coated to which the gold paste is to be applied is not limited in the material, shape, and dimension. As the material of the member to be coated, the present invention is applied to not only metal materials, semiconductor materials, and ceramic materials used in electric and electronic devices, semiconductor devices and elements, and the like, but also organic materials such as resins, and plastics. Besides, the shape and dimension can be any shape and dimension including a wire-shaped or chip-shaped member, a plate-shaped member such as a substrate and the like in the above-described uses. Furthermore, the number of members to be coated handled in one coating operation (of dipping and pulling up) is also not limited. One of merits of dip coating is efficiency that uniform coating films can be formed on a plurality of members to be coated.

In the gold paste application by the dip coating method, occurrence frequency of the formation of a peak in an applied coating film, and the surface roughness of the gold paste in the dipping tank is liable to depend on the pulling speed after the dipping. When the pulling speed is excessively high, a peak and the like is easily caused, but when the pulling speed is reduced, productivity is reduced because the production time is increased and the amount of the gold paste adhering to the member to be coated is reduced. In the present invention, the pulling speed is preferably 1 mm/s or more and 50 mm/s or less.

When the member to be coated is pulled up, an appropriate amount of the gold paste adheres to the member to be coated, and thus, the dip coating is completed. Thereafter, a drying treatment can be performed if necessary. The drying treatment is performed for volatilizing and removing the organic solvent from the applied gold paste.

The gold paste of the present invention can be provided for use as a material of a bump, an electrode, or a wiring, as well as use as a bonding material of an electronic or semiconductor element or member. When supplied to such use, the gold paste may be in the applied state as described above or in a dried state after the drying treatment, or the metal powder can be sintered to be formed into a dense metal powder sintered body. A metal powder sintered body obtained from the gold paste has denseness close to that of a gold thin film or bulk material. Besides, the gold paste of the present invention contains the high purity gold powder and does not contain, in the paste, impurities such as resins that can cause contamination, and therefore, the sintered body thereof is useful as a conductive material of an electrode or the like. Besides, the gold powder sintered body also works as a bonding material, and exhibits further denseness when heated and compressed, during which the sintered body bonds to a material to be bonded with high adhesiveness.

A heating temperature in a sintering step in which the metal powder sintered body is formed after applying the gold paste to a member to be coated is preferably 200° C. or more and 400° C. or less. When the temperature is less than 200° C., point contact and bond between metal particles is weak, and when the temperature is over 400° C., bonding between the metal particles excessively proceeds to cause necking in the gold powder to form a firm bond, and the resultant becomes too hard. Besides, it is concerned that heating at a temperature over 400° C. may reduce the performance of a semiconductor element or the like due to heat effect. A heating time in the sintering step is preferably 10 minutes or more and 120 minutes or less. An atmosphere employed in the sintering step may be the air, or may be a vacuum atmosphere or an inert gas atmosphere. Besides, the sintering step is performed under no pressure.

### Advantageous Effects of Invention

As described so far, a gold paste of the present invention is optimized for application by a dip coating method, and shape failure such as formation of a peak in a coating film after pulling up a member to be coated can be suppressed, and roughness of the gold paste in a dipping tank can be reduced. Besides, this gold paste has such favorable stability that a gold powder is not separated in the dipping tank. These effects are exhibited by selecting an organic solvent having a HSP distance Ra based on the suitable gold powder and an intrinsic viscosity value falling in a suitable range. The gold paste of the present invention has favorable sinterability at a low temperature, and can form a metal powder sintered body useful in various uses for electrodes, bonding, and sealing.

### BRIEF DESCRIPTION OF THE DRAWINGS

FIG. 1 is a diagram illustrating a method for evaluating formation of a peak in a gold paste of an embodiment of the present invention;

FIG. 2 is a diagram illustrating a method for evaluating surface roughness of the gold paste in the present embodiment; and

FIG. 3 illustrates photographs of samples after application (Example 1,Comparative Example 4, and Comparative Example 2) indicating examples of results of an evaluation test for application properties in dip coating of the present embodiment.

### DETAILED DESCRIPTION OF THE PREFERRED EMBODIMENTS

A preferred embodiment of the present invention will now be described. In the present embodiment, gold pastes were produced by mixing a gold powder produced by a wet reduction method with various organic solvents. Then, the gold pastes were applied by a dip coating method, the shape of a coating film (presence/absence of a peak) was evaluated, and usefulness as a bonding material was confirmed.

### Preparation of Gold Powder

A gold powder was produced in accordance with a production method of the conventional art (Patent Document 2) proposed by the present applicant described above. A chloroauric acid solution was prepared as a solution of a gold compound, and hydroxylammonium chloride was added thereto as a reducing agent, followed by stirring. Besides, the chloroauric acid solution was further added thereto, the resultant solution was stirred at 80° C. for 1 hour to obtain a violet transparent colloidal gold solution. Then, the chloroauric acid solution and hydroxylammonium chloride were added to the colloidal gold solution, followed by stirring at 80° C. for 0.5 hours for adjusting the particle size. After the reaction, a gold powder was filtered, and washed with isopropyl alcohol and a cyanide solution to obtain a gold powder. This gold powder had a purity of 99.99% by mass, and an average particle size of 0.3 μm.

The gold powder produced as described above was measured for the HSP through the following procedures by a visual observation method based on the Hansen method.
The gold powder freeze-dried was dispensed into containers, and several tens of solvents (such as acetone, and ethanol) having known HSP values were respectively added to the containers.
Each of the resultants was treated for 60 seconds in an ultrasonic water tank, and then manually shaken for mixing the gold powder and the solvent.
The resultant container was allowed to stand still for 10 minutes or 16 hours, the degree of dispersion of the gold powder in the solvent was visually observed for scoring (five-grade evaluation from 1 (dispersibility: good) to 5 (dispersibility: poor)).
Those having a score of grade 3 or higher were determined as solvents having favorable dispersibility, and a Hansen ball was created with reference to the HSP values of these solvents to obtain the HSP value of the gold powder.

By the above-described measurement method, the HSP (βd_{G}, βp_{G}, βh_{G}) of the gold powder of the present embodiment was measured as βd_{G}=16.5 MPa1/2, βp_{G}=12.7 MPa1/2, and βh_{G}=13.1 MPa1/2.

### Production of Gold Paste

In the present embodiment, gold pastes were produced with seven organic solvents shown in Table 1 below used. The distance Ra of each of these organic solvents was calculated referring to the HSPs (βdₛ, βpₛ, βhₛ) from database of spreadsheet “Hansen Solubility Parameters in Practice (HSPiP) version 4.1.03” and based on the HSP (βd_{G}, βp_{G}, βh_{G}) of the gold powder described above. Besides, regarding each of the organic solvents, an intrinsic viscosity value was measured under the conditions of a measurement temperature of 25° C. and a shear rate of 0.4/s (held for 60 seconds) with a rotational viscometer (manufactured by TA Instruments, DHR-2, geometry: stainless steel ϕ20 mm parallel plate, gap: 0.5 mm).

TABLE 1

| | | | | | | Intrinsic |
|---|---|---|---|---|---|---|
| | | δdₛ | δpₛ | δhₛ | Ra | Viscosity |
| | Organic Solvent | (MPa^{1/2}) | (MPa^{1/2}) | (MPa^{1/2}) | (MPa^{1/2}) | (mPa · s) |
| S1 | Bis(2-butoxyethyl)ether | 15.8 | 4.7 | 4.4 | 11.9 | 1.70 |
| S2 | Dodecyl Benzene | 17.1 | 0.4 | 0 | 18.0 | 6.21 |
| S3 | 2-Ethylhexyl Acetate | 15.8 | 2.9 | 5.1 | 12.7 | 1.60 |
| S4 | Pentadecane | 15.7 | 0 | 0 | 18.3 | 2.53 |
| S5 | Diethyl Malonate | 16.1 | 7.7 | 8.3 | 6.9 | 2.00 |
| S6 | 2-Isopropoxy Ethanol | 16.0 | 8.2 | 13.1 | 4.6 | 1.71 |
| S7 | Texanol | 15.1 | 6.1 | 9.8 | 7.8 | 12.60 |
| S8 | Triethylene Glycol/Di-2- | 16.7 | 1.5 | 4.2 | 14.3 | 9.29 |
| | Ethylhexanoate/Dodecyl | | | | | |
| | Benzene | | | | | |

* Ra is an HSP distance based on the gold powder.

The gold pastes were produced with the gold powder mixed with the organic solvents of Table 1. Here, the content ratio of the gold powder in each gold paste was set in a range of 90% by mass to 97% by mass. In using the organic solvents S-1 and S-2, a plurality of gold pastes having different content ratios of the gold powder were produced. Each of the thus produced gold pastes was measured, with a rotational viscometer, for a viscosity value under the same conditions as those described above except that the shear rate was set to 0.4/s and the gap was set to 0.05 mm.

The gold pastes thus produced were subjected to a test for evaluating application properties by dip coating. As a dip coater, a nano dip coater (manufactured by SDI, ND-0407-S5) was used, and as a member to be coated, a Dumet wire with a diameter of 0.2 to 0.3 mm having a Au dip coating film precedently formed in the vicinity of the tip was used. In the evaluation test, the gold slurry was held in a dipping tank (ϕ5 mm×height of 2.5 mm: 0.05 mL) of the dip coater, and the member to be coated was inserted into the gold paste by 2.5 mm, and immediately pulled up at a set pulling speed. The pulling speed was set in the range of 0.1 to 50 mm/s. After thus applying the gold paste, the resultant was subjected to drying by heating at 160° C. for 20 minutes in an electric furnace, and subjected to a sintering treatment by firing at 400° C. for 20 minutes.

Then, a gold paste applied region and a lower end part of the Dumet wire used as the member to be coated were observed with a digital microscope (manufactured by Keyence Corporation, VHX-950F) at 100× magnification. Besides, the surface of the gold paste in the dipping tank immediately after the pulling in the application step was also observed with the digital microscope. Based on results of these observations, presence/absence of a peak, the amount adhered, and the roughness on the paste surface were evaluated. Evaluation methods and evaluation criteria of these evaluation items were as follows.

### Evaluation of Formation of Peak

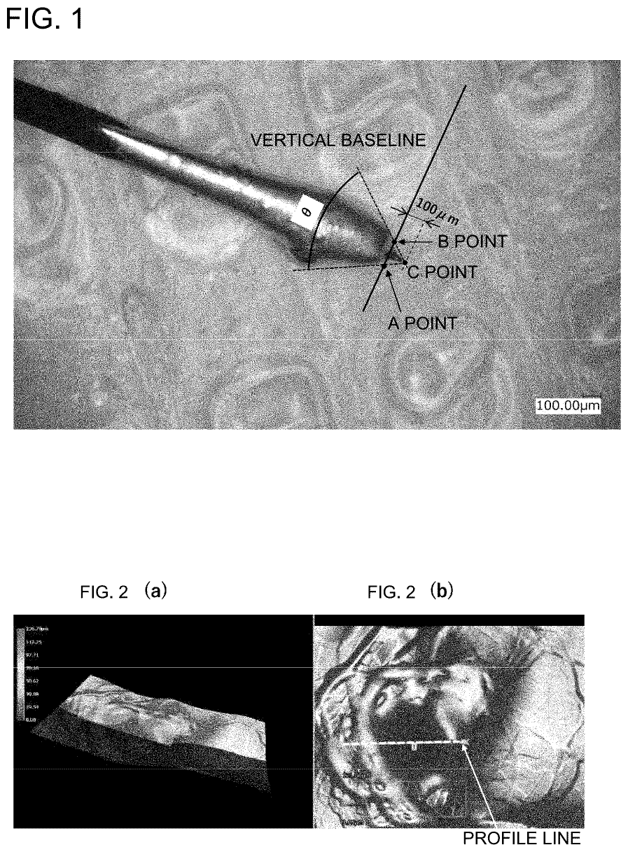

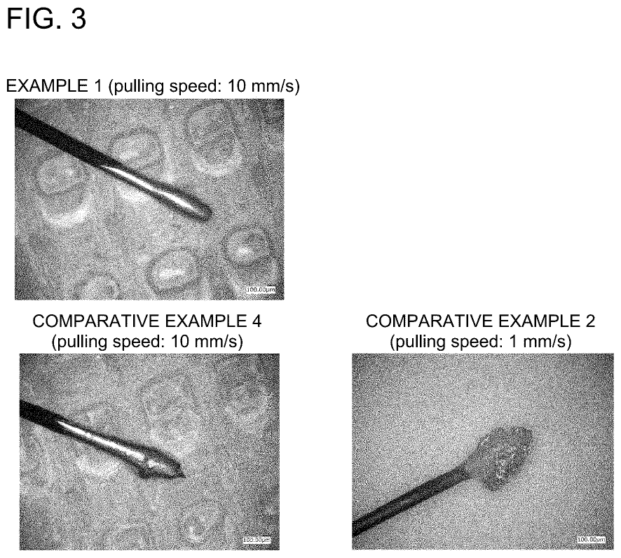

As shown in FIG. 1, using an observation image obtained, the tip of the wire having the paste adhering thereto was determined as a point C. A vertical baseline based on the wire was drawn to pass a point away, from the point C, in parallel to the wire by 100 μm in a pulling direction. Intersections between this vertical baseline and the periphery of the portion where the paste had adhered were assumed as a point A and a point B, and in a triangle formed by connecting these points, an angle θ was measured. The angle θ of 90° or more was determined as “excellent”, that of less than 90° and 80° or more was determined as “good”, and that of less than 80° was determined as “poor”.

### Evaluation of Amount Adhered

The obtained observation image was used to visually calculate a ratio of an area where the paste had adhered to the wire. A ratio of 90% or more was determined as “excellent”, that of less than 90% and 80% or more was determined as “good”, and that of less than 80% was determined as “poor”.

### Evaluation of Roughness on Paste Surface

The focus stacking function of a digital microscope is used to obtain shape data of irregularities on the surface of the gold paste in the dipping tank (FIG. 2 (a)). Then, a profile line was drawn to pass through the center of the irregularities (dipped portion) (FIG. 2 (b)). In this profile line, with a portion excluding the dipped portion set as a reference point, a length down to the lowest part in a portion recessed from the reference point was measured, and a length up to the highest part in a portion projected beyond the reference point was measured (in the measurement, the length was measured as a negative value for the recessed portion, and was measured as a positive value for the projected portion). The maximum absolute value of these measured lengths was recorded, and the maximum length of less than 100 μm was determined as “excellent”, that of 100 μm or more and less than 500 μm was determined as “good”, and that of 500 μm or more was determined as “poor”.

Results of the evaluation of the application properties by the dip coating performed in the present embodiment are shown in Table 2. Besides, examples of the results of the evaluation test are shown in Table 3. Table 3 shows results of Example 1 in which an excellent result free from a peak was obtained, Comparative Example 4 in which a peak was formed, and Comparative Example 2 in which the amount adhered was poor.

TABLE 2

| | Organic Solvent | | | Gold Paste | | | | | Amount Adhered | | Paste Surface Roughness | |
|---|---|---|---|---|---|---|---|---|---|---|---|---|
| | | | Intrinsic | Gold Powder | Viscosity of | Pulling | Peak | | Area | | Measured | |
| | | Ra | Viscosity | Content Ratio | Paste | Speed | θ | | Ratio | | Value | |
| | Type | (MPa^{1/2}) | (mPa · s) | (% by mass) | (Pa · s) | (mm/s) | (°) | Evaluation | (%) | Evaluation | (μm) | Evaluation |
| Example 1 | S1 | 11.9 | 1.70 | 96 | 785.0 | 0.1 | 101 | Excellent | 80 | good | −191 | good |
| | | | | | | 1 | 101 | Excellent | 95 | Excellent | −135 | good |
| | | | | | | 10 | 102 | Excellent | 100 | Excellent | −65 | Excellent |
| | | | | | | 50 | 93 | Excellent | 100 | Excellent | +58 | Excellent |
| Example 2 | | | | 95 | 585.3 | 0.1 | 103 | Excellent | 90 | Excellent | −103 | good |
| | | | | | | 1 | 104 | Excellent | 100 | Excellent | −74 | Excellent |
| | | | | | | 10 | 105 | Excellent | 100 | Excellent | +72 | Excellent |
| | | | | | | 50 | 102 | Excellent | 100 | Excellent | +88 | Excellent |
| Example 3 | | | | 97 | 2421.3 | 0.1 | 98 | Excellent | 95 | Excellent | −461 | good |
| | | | | | | 1 | 102 | Excellent | 100 | Excellent | −363 | good |
| | | | | | | 10 | 98 | Excellent | 100 | Excellent | +63 | Excellent |
| | | | | | | 50 | 103 | Excellent | 100 | Excellent | +60 | Excellent |
| Example 4 | S2 | 18 | 6.21 | 90 | 71.1 | 0.1 | 101 | Excellent | 100 | Excellent | −93 | Excellent |
| | | | | | | 1 | 102 | Excellent | 100 | Excellent | +16 | Excellent |
| | | | | | | 10 | 95 | Excellent | 100 | Excellent | +46 | Excellent |
| | | | | | | 50 | 100 | Excellent | 100 | Excellent | +138 | good |
| Example 5 | | | | 96 | 248.8 | 0.1 | 98 | Excellent | 95 | Excellent | −73 | Excellent |
| | | | | | | 1 | 95 | Excellent | 100 | Excellent | −63 | Excellent |
| | | | | | | 10 | 101 | Excellent | 100 | Excellent | +100 | good |
| | | | | | | 50 | 91 | Excellent | 100 | Excellent | +87 | Excellent |
| Example 6 | | | | 97 | 882.5 | 0.1 | 98 | Excellent | 90 | Excellent | −198 | good |
| | | | | | | 1 | 96 | Excellent | 100 | Excellent | +75 | Excellent |
| | | | | | | 10 | 88 | good | 100 | Excellent | +91 | Excellent |
| | | | | | | 50 | 80 | good | 100 | Excellent | +99 | Excellent |
| Example 7 | S3 | 12.7 | 1.60 | 96 | 525.0 | 0.1 | 81 | good | 95 | Excellent | −131 | good |
| | | | | | | 1 | 97 | Excellent | 95 | Excellent | −54 | Excellent |
| | | | | | | 10 | 98 | Excellent | 100 | Excellent | +88 | Excellent |
| | | | | | | 50 | 99 | Excellent | 100 | Excellent | +139 | good |
| Example 8 | S4 | 18.3 | 2.53 | 96 | 328.8 | 1 | 93 | Excellent | 100 | Excellent | −54 | Excellent |
| | | | | | | 10 | 98 | Excellent | 100 | Excellent | +135 | good |
| Comparative | S5 | 6.9 | 2.00 | 96 | 9543.0 | 1 | 110 | Excellent | 75 | poor | −495 | good |
| Example 1 | | | | | | 10 | 100 | Excellent | 75 | poor | −1095 | poor |
| Comparative | S6 | 4.6 | 1.71 | 96 | 1647.3 | 1 | 106 | Excellent | 50 | poor | −989 | poor |
| Example 2 | | | | | | 10 | 128 | Excellent | 60 | poor | −1371 | poor |
| Comparative | S7 | 7.8 | 12.60 | 96 | 1344.0 | 1 | 107 | Excellent | 75 | poor | +42 | Excellent |
| Example 3 | | | | | | 10 | 77 | poor | 100 | Excellent | +63 | Excellent |
| Comparative | S8 | 14.3 | 9.29 | 96 | 1004.3 | 0.1 | 98 | Excellent | 95 | Excellent | −132 | good |
| Example 4 | | | | | | 1 | 88 | good | 100 | Excellent | +92 | Excellent |
| | | | | | | 10 | 68 | poor | 100 | Excellent | +118 | good |
| | | | | | | 50 | 79 | poor | 100 | Excellent | +130 | good |

It is understood, from the results of the evaluation test of the present embodiment, that the application properties and shape stability of a gold paste can be ensured by optimizing both the HSP distance Ra from the gold powder and the intrinsic viscosity of an organic solvent to be used. Gold pastes of Examples 1 to 9 satisfying these requirements were evaluated as “good” or better in all of the formation of a peak in dipping, the amount adhered, and the surface roughness of the paste in the dipping tank. In contrast to these examples, in Comparative Examples 1 and 2, the HSP distance Ra of the organic solvent was less than 7.0, and the results of the amount adhered and the paste surface roughness were not preferable. Besides, in Comparative Examples 3 and 4, the intrinsic viscosity value of the organic solvent was too high, and hence a peak was liable to be easily formed.

Referring to Examples 1 to 3, and Examples 4 to 6, respectively using the same organic solvents, the viscosity of the gold paste is liable to be largely affected by the content ratio of the gold powder. Besides, there is no proportional relationship between the intrinsic viscosity value of the organic solvent and the viscosity of the gold paste. In addition, it is presumed, based on the results of the present embodiment, that the viscosity of the entire gold paste only slightly affects the application properties. In comparison between Examples and Comparative Example 2, it seems that the viscosity of the gold paste is preferably low to some extent, but referring to Comparative Examples 2 to 4, this is not necessarily true. As described above, for the application properties at the time of dipping in a gold paste, priority should be given to the optimization of the HSP and the intrinsic viscosity of an organic solvent.

Next, the gold pastes of Examples 1 to 3, 4, 5, and 7 were subjected to a bonding strength test. In this bonding test, each gold paste was applied in the vicinity of the center on the surface of a Si chip (area: 9 mm2) on which a gold film of 300 nm had been precedently formed (application area: about 1 mm²), and another Si chip (area: 1 m²) having the same gold film formed thereon was further placed thereon, and thus, a sample was produced (in a layered structure of Si chip/gold paste/Si chip). It is noted that the Si chip was placed immediately after applying the gold paste, and drying and sintering were not performed at this stage. Thereafter, the thus produced sample was heated to sinter and bond the gold paste to obtain a bonded body. In this heat treatment, a temperature of 230° C. was attained by heat transfer from a heating tool, and a heating time was set to 30 minutes.

Then, the thus produced bonded body was subjected to a shearing test. In the shearing test, a blade was contacted the upper chip (area: 1 mm²) at a constant speed from the lateral direction of the bonded body and was advanced to measure rupture stress (N) applied when rupture (peeling of the chip) occurred. Based on this stress value and the area (1 mm²) of a bonded portion after the rupture, bonding strength (MPa) per unit area was calculated. This test was performed a plurality of times using five samples to calculate averages of the rupture stress and the bonding strength thereof. Results thus obtained are shown in Table 3. In this shearing test, assuming the bonding strength in bonding electronic components, the acceptance criterion was set as 15 MPa or more.

TABLE 3

| | | | Gold Paste | | Average of | Average of | |
|---|---|---|---|---|---|---|---|
| | Organic Solvent | | Gold Powder | | Rupture | Bonding | |
| | | Ra | Content Ratio | Viscosity | Stress | Strength | |
| | Type | (MPa^{1/2}) | (% by mass) | (Pa · s) | (N) | (MPa) | Result |
| Example 1 | S1 | 11.9 | 96 | 785.0 | 37.2 | 37.2 | Acceptable |
| Example 2 | | | 95 | 585.3 | 32.5 | 32.5 | Acceptable |
| Example 3 | | | 97 | 2421.3 | 39.0 | 39.0 | Acceptable |
| Example 4 | S2 | 18.0 | 90 | 71.1 | 18.6 | 18.6 | Acceptable |
| Example 5 | | | 96 | 248.8 | 38.5 | 38.5 | Acceptable |
| Example 7 | S3 | 12.7 | 96 | 525.0 | 20.2 | 20.2 | Acceptable |

Referring to Table 3, the bonded portion formed by using the gold paste of each Example has suitable bonding strength as a bonded portion of an electronic component. Accordingly, it is deemed that the gold paste of the present invention can form a coating film in a suitable shape in dip coating, and has a suitable function as a bonding material after the application.

### Industrial Applicability

A gold paste of the present invention is optimized for application by a dip coating method by selecting an organic solvent having a proper HSP distance Ra from a gold powder, and further having a suitable intrinsic viscosity value. The present invention enables a paste application operation to be conducted while reducing shape failure (formation of a peak) in a coating film in gold paste application and gold paste roughness in a dipping tank otherwise caused in the dip coating method. The gold paste of the present invention is applicable to low-temperature process, and is effective for use in bonding, electrode and wiring formation, sealing and the like in various uses in electronic components, semiconductor devices, power devices, and MEMS.

What is claimed is:

1. A gold paste comprising a gold powder, and an organic solvent,
wherein the gold powder comprises gold with a purity of 99.9% by mass or more, and has an average particle size of 0.1 μm or more and 0.5 μm or less, and
the organic solvent has a distance Ra in a Hansen solubility parameter from the gold powder of 7.0 MPa1/2 or more, and has an intrinsic viscosity value measured at a temperature of 25° C. and a shear rate of 4/s with a rotational viscometer of 1.5 mPa·s or more and 6.5 mPa·s or less.

2. The gold paste according to claim 1, wherein the organic solvent has a boiling point of 140° C. or more and 360° C. or less.

3. The gold paste according to claim 1 or 2, wherein a content ratio of the gold powder is 85% by mass or more and 97% by mass or less based on a total mass of the gold paste.

4. A dip coating method for a gold paste in which at least a part of a member to be coated is dipped in and pulled out of a dipping tank holding the gold paste for applying the gold paste to the member to be coated,
wherein the gold paste is the gold paste defined in any one of claims 1 to 3.

5. The dip coating method for a gold paste according to claim 4, wherein a pulling speed of the member to be coated is 1 mm/s or more.
